(19) United States
(12) Patent Application Publication
(10) Pub. No.: US 2021/0380445 A1
(43) Pub. Date: Dec. 9, 2021

(54) ROLL ASSEMBLY, IN PARTICULAR FOR WATER TREATMENT, AND TREATMENT APPARATUS

(71) Applicant: Jürgen Berthold, Eckental (DE)

(72) Inventors: Jürgen BERTHOLD, Eckental (DE); Hermann BERTHOLD, lgensdorf (DE)

(21) Appl. No.: 17/342,780

(22) Filed: Jun. 9, 2021

(30) Foreign Application Priority Data
Jun. 9, 2020 (DE) 10 2020 115 342.2

(51) Int. Cl. C02F 1/52; C02F 1/461; C02F 1/54; C02F 1/74; B01F 7/12; B01F 7/00; B01D 19/02; B01F 15/02

(52) U.S. Cl. CPC C02F 1/5281; C02F 1/46104; C02F 1/547; C02F 1/74; B01F 7/12; C02F 2101/20; B01D 19/02; B01F 15/0227; C02F 2301/024; C02F 2305/023; B01F 7/00508

(57) ABSTRACT

A roll assembly for increasing a surface area of a fluid, in particular for water treatment, including at least one shaft which in each case bears at least one roll, a drive for the at least one shaft, a fluid feed which is arranged above the respective roll and guides the fluid to the respective roll, and a collecting trough for the fluid, the collecting trough being assigned to the respective roll, wherein the roll has two lateral surfaces in the shape of cylinder jackets which are spaced apart in the radial direction, are each in the form of a mesh and project on the bottom side of the roll into the collecting trough.

### CROSS-REFERENCE TO RELATED APPLICATIONS

The present application claims priority of DE 10 2020 115 342.2, filed Jun. 9, 2020, the priority of this application is hereby claimed, and this application is incorporated herein by reference.

### BACKGROUND OF THE INVENTION

The invention relates to a roll assembly for increasing the surface area of a fluid, in particular for water treatment, and to a treatment apparatus for water treatment.

In many work and economic sectors, liquids are generated which are laden with particles, in particular with suspended matter or colloids. In many applications, corresponding particles of sizes, for example, in the μm or nm range, are intended to be separated from the fluid. An essential application in this regard is the treatment of water, in particular in order to sufficiently purify service water such that it can be introduced into rivers or similar, or in order to directly obtain drinking water from the service water. For this purpose, aside from filtering for the removal of relatively large items of suspended matter, use is made in particular of flocculation by addition of flocculants and subsequent sedimentation, or activated carbons may be added, in particular in order for odorous substances or flavoring agents and organic compounds to be adsorbed thereon.

A known problem here is that relatively high loads of organic molecules, in particular of relatively large organic molecules, in the water cannot themselves be flocculated, and can also disrupt the flocculation of other suspended matter. Furthermore, in particular, the removal of organometallic suspended matter is laborious. One possible approach for assisting the treatment is oxidation or hydration by OH⁻ or H₃O⁺ radicals. However, corresponding approaches require relatively long process periods or downtimes for water treatment, and high throughputs are thus possible only with extremely large treatment plants.

This is a problem in particular if it is the intention for water treatment to be performed locally for an individual facility. For example, it may be desired to treat water which originates from a biogas plant and which is laden with fermentation waste, or which is otherwise laden with organic waste such as faeces, straw, grass, etc. Water laden in this way is often also referred to generally as “slurry”. Even after separating off relatively large impurities, for example by pressing and/or filtering, and after preliminary processing steps for separating fibers, for example by flocculation, corresponding waste water is still heavily laden with organic colloids, organometallic compounds and the like, thus resulting in the problems explained above.

### SUMMARY OF THE INVENTION

The invention is thus based on the object of improving throughputs in a fluid or in particular water treatment facility of a given size, and of specifying a small treatment apparatus that can nevertheless achieve good throughputs.

The object is achieved according to the invention by a roll assembly for increasing a surface area of a fluid, in particular for water treatment, which comprises at least one shaft which bears at least one roll, a drive for the at least one shaft, a fluid feed which is arranged above the respective roll and guides the fluid to the respective roll, and a collecting trough for the fluid, said collecting trough being assigned to the respective roll, wherein the roll has two lateral surfaces in the shape of cylinder jackets which are spaced apart in the radial direction, are each in the form of a mesh and project on the bottom side of the roll into the collecting trough.

In the roll assembly according to the invention, the fluid flows, in particular via or through the lateral surfaces in the form of meshes, into the collecting trough, and is initially retained there. As a result of the rotation of the roll, depending on the fluid level in the collecting trough, one or both lateral surfaces in mesh form are led through the fluid and swirl or entrain said fluid. This results firstly in high dynamics or a turbulent flow between the lateral surfaces and thus good mixing, which can contribute to accelerating reactions for water treatment that take place in the fluid, for example hydration of suspended matter. Furthermore, air from the surroundings of the roll is introduced into the fluid, which can firstly contribute to the oxidation of suspended matter and secondly leads to foam formation and thus to an enlargement of the surface area of the fluid, in particular if the fluid contains tensides or other foaming agents. In tests, for example for a water quantity of 2 l water, a foam volume of approximately 1 m³ resulted in a short time, the surface area of which can be estimated as approximately 100,000 m².

It is essential here that the lateral surfaces in the form of meshes simultaneously act as foam breakers, whereby individual air bubbles of the foam typically have a lifetime of only a few ms, for example 1-2 ms. In order to achieve a rapid formation and a rapid breakdown of foam, rotational speeds of the shaft or shafts of greater than 100 rpm are preferably used. For example, rotational speeds between 300 rpm and 3000 rpm, in particular between 500 rpm and 2000 rpm, specifically between 800 rpm and 1200 rpm, for example a rotational speed of 1000 rpm, may be used.

As a result of the rapid formation and breakdown of foam, a high fluid throughput can be achieved despite the large surface area that is briefly provided. In tests with a roll assembly with 6 shafts each bearing two rolls, with a structural space requirement of approximately 0.75 m³, it was possible to achieve a fluid throughput of approximately 30,000 I/h.

In the context of water treatment, the guidance of the fluid through the roll assembly can serve in particular for initially producing a mixture with freely suspended matter, which can subsequently, in a downstream physical separation, be flocculated or bound to activated carbon, in order for them to be separated from the fluid by sedimentation. Here, numerous advantages are achieved by means of the approach described above. For example, the foam formation or the formation of a very large fluid surface area has the effect that, during treatment of water, tensides accumulate at said surface and form a type of filter surface, and colloids of hydrophobic matter or matter of low polarity can thus be broken up effectively by adsorption of said matter on the tensides. Here, the matter may be matter that was already present in the fluid previously, or in particular also matter that has formed during the course of preprocessing or even for the first time within the roll assembly by oxidation or hydration. Thus, in particular relatively large organic molecules, viruses, bacteria and the like are broken up by oxidation or hydration into relatively small components that can be bound to tensides, whereby flocculation is in turn made possible.

Furthermore, the highly dynamic, in particular turbulent, flow of the fluid in the region of the lateral surfaces, and in particular the rapid foam formation and destruction leads on the one hand to an acceleration of reactions in the fluid, that is to say in particular of the hydration of foreign matter by means of OH⁻ and H₃O⁺ radicals. As will be discussed in more detail further below, it is furthermore possible for air with a high oxygen or ozone content to be conducted into the roll region, which air can, owing to the large fluid surface area, contribute to the oxidation of foreign matter. Since the residues of corresponding reaction, if they are of low polarity, are bound by the filter surface of the tensides situated at the surface, as explained above, said residues can be flocculated in an effective manner in a downstream step.

Since the organic residues are thus separated off, metal ions which can be precipitated by forming poorly soluble hydroxides by providing a sufficiently high OH⁻ concentration in the fluid remain for the organometallic compounds. For example, slurry from biogas plants typically in any case has a relatively high pH of, for example, more than 8, and therefore a large portion of the metals precipitates as hydroxide. As will be explained later, it is also possible for the fluid within the context of supply to the roll assembly to be conducted past electrodes of an electrolysis device, as a result of which the content of OH⁻ radicals can be increased further, and therefore the precipitation of metal hydroxides can be further improved.

The respective roll can comprise, for example, two supporting disks which are fastened to the shaft and extend radially outwards therefrom. The lateral surfaces can be fastened to the supporting disks at different radii. It is also possible, however, to fasten the lateral surfaces to the shaft in another way, for example by star-shaped struts or the like.

It can be advantageous to fasten a plurality of rolls, in particular precisely two rolls, to a common shaft. This enables greater rigidity of the lateral surfaces to be achieved in comparison to a single long roll, with the design otherwise being the same. In addition, it can be advantageous, for example, to use two rolls, for which fluid is supplied from different sides of a housing of the roll assembly.

The collecting trough is in particular fluid-tight and has no openings, and therefore the fluid can be discharged from the collecting trough exclusively via an upper edge of the collecting trough. After leaving the collecting trough, the fluid can be discharged directly via an outlet of the roll assembly, for example into a fluid vessel, from which the fluid can be removed for further processing and/or from which the fluid is supplied again via the fluid feed to the roll or to another roll of the roll assembly. However, it is also possible for the fluid on leaving a collecting trough to first of all flow into a further collecting trough of another roll such that the fluid is further processed by this.

The outer of the lateral surfaces may have a spacing of less than 3 mm or less than 2 mm or less than 1.5 mm to a base of the collecting trough. This may in particular be a minimum spacing. The minimum spacing may be dependent on the rotational position of the shaft or roll. In this case, the stated spacing may in particular be the minimum spacing that occurs during the course of the rotation of the roll. As will be discussed in more detail further below, it can be advantageous for the water treatment to utilize the smallest possible spacings between the lateral surface and the base of the collecting trough. For example, it is possible for the spacing to be between 1 mm and 1.2 mm or even less than 1 mm. For example, the spacing may be less than 0.5 mm or less than 0.3 mm. The spacing is preferably selected such that mechanical contact between the lateral surface and the base of the collecting trough during the operation of the roll assembly is avoided, because this would lead to wear of the components and, under some circumstances, to contamination of the fluid. The lower limit for the spacing is thus dependent on expected tolerances and on the stiffness of the mesh that forms the outer lateral surface.

For the treatment of water, certain reactions or interactions for foreign matter in the water should be brought about in a targeted manner, that is to say for example an interaction between foreign matter and tenside should be made possible, or an oxidation or hydration of the foreign matter should be made possible. These interactions can be impeded by a hydrate shell around the respective foreign matter. Corresponding hydrate shells can, owing to the strong polarity of water molecules, form in the manner of clusters around ions or polar molecules. Even non-polar molecules or molecules with low polarity may however be surrounded by a hydrate shell. For example, the effect of water-avoiding hydration is known, in the case of which the mere presence of non-polar molecules or molecules of low polarity restricts the freedom of movement of the surrounding water and can thus lead to the formation of structures with a certain stability in the surrounding water.

By means of a small minimum spacing between the outer lateral surface and the base of the collecting trough and the formation of the lateral surface as a mesh, water is conducted into said constriction by the rotation of the roll and is initially charged with intense pressure owing to the reduction of the spacing, and is subsequently rapidly expanded. This, and the shear forces that arise in the region of the constriction, can have the effect that hydrate shells of colloids or other foreign matter are broken up, such that these can for example be oxidized, hydrated or bound to tensides.

In one example, the diameter of the outer lateral surface can be approx. 15 to 20 cm. The spacing between the lateral surfaces can be, for example, between 1 cm and 1.5 cm. The mesh bars of the mesh forming the lateral surfaces can have a thickness of approx. 1 mm and, as will be also discussed later, in particular have an offset such that overall an extent of 3 mm in the radial direction of the roll can result. These dimensions lead during rotation of the roll to the above-explained rapid compression and expansion of fluid in the region of the constriction between the exterior lateral surface and the base of the collecting trough.

At least the outer surface area of the outer of the lateral surfaces can have a sawtooth form, apart from the mesh apertures in the circumferential direction. This can be achieved in that the mesh bars forming the mesh are offset. In other words, a radial outer surface of the mesh bars runs at an angle to the circumferential direction, specifically preferably such that, starting from a first aperture of the mesh, the distance between mesh surface and base of the collecting trough decreases continuously until it abruptly increases at an edge of the following aperture. This shape and a sawtooth shape in general is particularly advantageous for the above-explained breaking opening of hydrate shells of foreign matter.

The surface of the inner lateral surface is particularly advantageously also in sawtooth form. This firstly results in a low outlay on production since the same mesh material can be used to form both lateral surfaces. Secondly, such a shape makes it possible to achieve a particularly dynamic flow in the region of the lateral surfaces, the flow contributing to the increase in the surface area and to the acceleration of reactions in the fluid.

The inner and/or the outer of the lateral surfaces can be formed by a rhomboidal mesh, in particular by a rhomboidal expanded mesh. The axes of symmetry of the respective rhomboidal aperture can extend in the circumferential direction and axial direction of the roll. If such a mesh is produced in the form of an expanded mesh, an offset of the individual mesh bars results during the expansion process, i. e. an inclination of the surfaces in relation to the mesh plane or, after shaping of the mesh with respect to the lateral surface, in relation to the circumferential direction and thus in particular the above-explained sawtooth profile.

The fluid supply can be formed by a pipe which, at least in one axial portion that extends above the outer lateral surface in the axial direction of the shaft, has a slot through which fluid conducted in the pipe can escape from the pipe. For example, use can be made of a rectangular pipe, the side surfaces of which lie obliquely with respect to the horizontal. The slot can be made in particular at the lowest corner of said cross section. Such a configuration makes it possible with little outlay to achieve a relatively uniform distribution of the fluid along the axial direction of the shaft. In addition, the described configuration needs relatively little maintenance. Alternatively, for example, a perforated metal sheet or the like can be used to supply the fluid from above to the respective roll.

The respective roll can comprise a fluid-tight inner shell which is in the form of a cylinder jacket and extends between the shaft and the inner lateral surface. This can be fastened, for example, together with the lateral surfaces formed by the mesh to a supporting disk or to another supporting means. The spacing between the inner shell and the inner lateral surface can be approximately equal to the spacing between the inner lateral surface and the outer lateral surface in the radial direction, for example can deviate by a maximum of 2.

The use of the fluid-tight inner shell is advantageous since relatively large radii are desirable for the inner and outer lateral surface in order to provide a large surface area for interaction with the fluid. At the same time, a relatively thin shaft should preferably be used in order to avoid an unnecessary use of material and to achieve a small moment of inertia of the shaft. The use of the inner shell nevertheless makes it possible to keep the fluid close to the lateral surfaces and thus, for example, to suppress the formation of a mountain of foam which is not dissolved for a relatively long time. The dimensions of the inner shell can be selected such that it projects on the bottom side of the roll into the collecting trough. When the collecting trough is filled, the inner shell can thus always be in contact with the fluid.

The roll assembly can comprise a first shaft which bears a first roll, to which a first collecting trough is assigned, and a second shaft which runs parallel to the first shaft and bears a second shaft, to which a second collecting trough is assigned. The first collecting trough and the second collecting trough can be arranged adjacent to one another in a direction perpendicular to the axial direction of the rolls, wherein a side wall of the first collecting trough at the same time forms a side wall of the second collecting trough or is connected fluid-tightly to a side wall of the second collecting trough. The above-described arrangement leads to fluid which passes over the side wall of the first collecting trough being able to be collected by the second collecting trough, and vice versa. The direction of rotation of the rolls here predetermines the direction of transport of fluid between the collecting troughs. The transport direction corresponds here generally to the direction in which the lower edge of the rolls moves.

It is assumed below that fluid is conveyed by the first roll out of the first collecting trough into the second collecting trough. However, the statements also apply with appropriate adaptation to a reverse transport of fluid when the direction of rotation of the rolls is reversed. The effect achieved by the described procedure is that fluid which is supplied to the first roll initially interacts therewith and thus a first treatment of the fluid is already carried out. At the same time, a portion of the fluid processed by the first roll is in each case transported on to the second collecting trough where it is processed again by the second roll. At the same time, that portion of the fluid which is supplied directly to the second roll is thereby mixed thoroughly in the second collecting trough with the fluid previously processed by the first roll.

Within the scope of processing the fluid by the second roll, there are thus already smaller concentrations of foreign matter to still be processed, i. e. for example colloids which are still contained in water clusters, non-oxidized organic molecules, non-polar molecules that are not bound to tensides, etc. It has been recognized that such a partially parallel and partially serial treatment of the fluid by the first and second roll achieves an improved combination of high fluid throughputs and a low portion of non-processed foreign matter both compared to a purely serial treatment and to a purely parallel treatment by the two rolls.

In general, the roll assembly can comprise a plurality of the shafts, wherein the shafts are mounted on a housing and penetrate at least one housing wall of the housing. In addition or alternatively, the shafts, in particular outside the housing, can be coupled in terms of movement to one another. In addition or alternatively, the fluid feeds of the rolls arranged on the shafts can be connected to a common pump for loading the fluid feeds with the fluid. The housing is in particular fluid-tight. The leadthroughs of the shafts through the housing can be sealed by shaft sealing rings or the like. The drive and/or means for coupling the shafts in terms of movement, i. e. for example V-belts or the like, are preferably arranged externally to the housing and thus in a dry region. An electric motor, for example, can be used as the drive. The pump can likewise be arranged outside the housing. In particular, a pipe which forms the respective fluid feed or feeds the latter can be guided through that side wall or side walls on which the shaft is mounted or which is or are penetrated by the shaft. The shaft can in particular penetrate two mutually opposite side walls of a housing. The drive, in particular, can be arranged here on one side and the movement coupling on the opposite side of the housing.

One possibility of achieving a greater fluid throughput through the roll assembly is to use a plurality of rolls to which the fluid is supplied in parallel. It has been established here that a particularly compact design of the roll assembly is made possible if the rolls or shafts or the associated collecting troughs are arranged vertically one above another. If, as explained above, a first and second shaft or roll are used with interconnected collecting troughs, a plurality of said groups of pairs of rolls can be arranged vertically one above another. For example, the roll assembly can comprise six shafts of which in each case two are arranged at the same height and, as explained above, have mutually adjacent collecting troughs, wherein three groups of said shafts are arranged vertically one above another. A fluid outlet for a plurality of collecting troughs arranged one above another can be arranged here laterally adjacent to the collecting troughs and can thus extend vertically essentially through the entire roll assembly.

The invention also relates to a treatment apparatus for fluid treatment, with a fluid vessel which comprises a fluid inlet for supplying fluid to be treated, and a fluid outlet for conducting away treated fluid, wherein the treatment apparatus comprises a roll assembly according to the invention, wherein an intake opening of the fluid vessel is fluidically connected to the at least one fluid feed, in particular via the or a pump, wherein a fluid outflow of the roll assembly, to which fluid passing via the or a side wall of the at least one collecting trough can be supplied, opens into the fluid vessel. It is thus possible for fluid to be fed from the fluid vessel via the intake opening to the roll assembly or to the individual rolls, and, after treatment by means of the roll or rolls, the fluid can be conducted via the fluid outflow back into the fluid vessel. This makes it possible in particular that at least a proportion of the fluid situated in the fluid vessel passes multiple times through the roll assembly, whereby better purification can be achieved.

In particular an apparatus for physical separation can be connected downstream of the fluid outflow. The fluid inlet can feed in a fluid which is to be treated and to which, for example, tensides are already added, in order to achieve the above-explained effect in the roll assembly. The fluid inlet can be connected in particular to preceding treatment steps, for example to apparatuses for oxidizing foreign matter in the fluid, to fiber separation or to a pressing or filtering step for removing solids.

The treatment apparatus can be operated in particular continuously so that fluid is supplied continuously via the fluid inlet and is discharged continuously via the fluid outlet. By means of suitable guidance of the fluid in the fluid vessel, it can be achieved in particular that, here, the fluid typically passes through the roll assembly at least once, in particular multiple times. As a result of the recirculation of the fluid from the roll assembly into the fluid vessel, the concentration of foreign matter for which treatment in the roll assembly is still desired would continuously decrease if it is initially assumed that no further fluid is fed via the fluid inlet and no fluid is discharged via the fluid outlet, because, in each case, a proportion of said foreign matter is conducted together with the fluid to the roll assembly and at least partially processed there. By coordination of the fluid quantity that is fed via the fluid inlet and discharged via the fluid outlet with the fluid quantity that is conducted via the intake opening to the roll assembly per unit of time, it is thus possible to set what remaining quantity of foreign matter still to be processed by the roll assembly is to be tolerated in the fluid that is discharged via the fluid outlet.

Since it can be at least approximately assumed that the remaining concentration of the non-processed foreign matter in the region of the fluid outlet decreases exponentially with the average residence time of the fluid in the fluid vessel, even with relatively short average residence times a sufficiently thorough treatment can be carried out which, for example, makes it possible for good water quality of the treated water, in particular drinking water quality, to be able to be achieved in a subsequent physical separating step despite a relatively short residence time.

The intake opening is preferably arranged at a sufficiently low point in the fluid vessel that it lies below the fluid surface during normal operation, and therefore fluid can be sucked up, for example via the pump, and can be conveyed to the roll assembly. The roll assembly is preferably at a higher point than the fluid vessel, in particular directly above the fluid vessel. After passing through the roll assembly, fluid can emerge from the latter, in this case on the base side, and can be conducted back into the fluid vessel in particular directly or alternatively also via connecting lines.

As already explained above, the fluid supplied to the fluid vessel via the fluid inlet is thoroughly mixed with the fluid flowing back from the roll assembly into the fluid vessel. This leads to fluid already being sucked up via the intake opening in regular operation, the concentration of colloids to be processed or of other foreign matter in which fluid is relatively low. It has been recognized here that this can lead to improved treatment.

The roll assembly can be arranged in the or a housing which has a cavity which is laterally adjacent to the collecting trough or to at least one of the collecting troughs, is open on its bottom side and into which the fluid vessel opens and thus forms the fluid outflow of the roll assembly. In other words, fluid which passes over the side wall of the collecting trough on the cavity side can drop directly back into the fluid vessel. This achieves a particularly compact and simple design of the treatment apparatus.

The treatment apparatus preferably has a fluid-deflecting plate which projects into the fluid vessel and ends freely in the fluid vessel, wherein the fluid inlet of the fluid vessel and the fluid outflow of the roll assembly are arranged on one side of the fluid-deflecting plate and the fluid outlet of the fluid vessel and/or the intake opening are arranged on the opposite other side of the fluid-deflecting plate. The fluid-deflecting plate can be composed, for example, of sheet metal, but can also be formed from a different material.

By means of the fluid-deflecting plate arranged as described above, the fluid flows from the fluid inlet and from the fluid outflow are both deflected on their path to the fluid outlet or to the intake opening by the fluid-deflecting plate and in the process mixed. The reduction, already described above, in the concentration of foreign matter or colloids that have not yet been processed can thereby be achieved.

The fluid-deflecting plate can in particular be flat. It can in particular be arranged or connected to the fluid vessel in such a manner that fluid can pass the fluid-deflecting plate exclusively below a free end of the fluid-deflecting plate. In particular, the upper edge and/or the lateral edges of the fluid-deflecting plate are connected fluid-tightly to the wall of the fluid vessel. The fluid-deflecting plate can extend at an angle to the horizontal, in particular at an angle of between 20° and 70° or between 30° and 60°, for example at an angle of 45°, to the horizontal. This can be particularly advantageous for thoroughly mixing the fluid flows, for example if the fluid inlet ends in the fluid vessel substantially horizontally and the fluid outflow of the roll assembly substantially vertically.

The fluid inlet and the fluid outlet can be arranged on opposite sides of the fluid vessel. They can be arranged substantially at the same height. For example, the vertical position of the fluid inlet can differ from the vertical position of the fluid outlet by less than 50% or less than 30% or less than 20% of the height of the fluid vessel.

The fluid outlet of the fluid vessel can be arranged above the free end of the fluid plate, wherein the intake opening is arranged lower than the fluid outlet, in particular below the free end of the fluid-deflecting plate. The effect which can be achieved by this is that fluid on the path from the fluid inlet to the fluid outlet is necessarily conducted past the intake opening, and therefore at least a large portion of the fluid passes at least once through the roll assembly and it is thus avoided that fluid with a high concentration of as yet unprocessed colloids or other foreign matter is discharged via the fluid outlet. It is particularly advantageous here if the fluid inlet is also arranged above the free end.

The treatment apparatus can have at least one pair of electrodes which project into the fluid vessel, wherein an electrolysis device is designed to charge the electrodes with voltage in order to carry out electrolysis of the fluid. The electrodes are preferably metal sheets. They can preferably be arranged in the region of the fluid inflow. The surfaces of the electrodes can run in particular substantially parallel to the flow direction from the fluid inflow to the fluid outflow. The polarity of the electrodes can be interchanged periodically, for example each minute, in order to avoid an accumulation of salt on the electrodes.

Electrolysis of the fluid, i. e. in particular of water, is advantageous for a plurality of reasons. Firstly, the air above the fluid in the fluid vessel is thereby enriched with oxygen. In addition, radicals or ozone having a particularly strong oxidizing effect typically arise. Air enriched in this way can be conducted to the roll assembly in order to oxidize foreign matter there on the large surface area of the fluid.

In addition, the electrolysis, which is in particular carried out continuously, leads to the portion of OH⁻ and H₃O⁺⁻ ions in the water increasing, as a result of which hydrolysis of foreign matter or colloids in the fluid is promoted. Since, with fluid being conveyed to a sufficiently high extent through the intake opening, the conveying speed of the fluid can be significantly above the diffusion speed of said radicals in the fluid, the portion of said radials can also be increased by said electrolysis in the region of the roll assembly, as a result of which a significantly higher hydrolysis activity also arises there. This is relevant in particular since, as explained above, hydrate shells or water clusters around colloids and other foreign matter can be broken up in the roll assembly, and therefore hydrolysis, in particular oxidation by OH⁻ ions, for portions of the colloids or of the foreign matter can be possible only there.

As already explained above, the primary purpose of the roll assembly and thus of the treatment apparatus is to produce a mixture of the fluid and the contained foreign matter, in which the foreign matter can be subsequently readily precipitated physically. Nevertheless, it is possible that portions of the foreign matter can already be precipitated in the roll assembly or in the fluid vessel. For example, metal ions remaining after oxidation of organometallic substances can precipitate as poorly soluble metal hydrates. It is also possible that the fluid supplied via the fluid inlet already contains flocculants, for example if processing in preparatory processing steps comprises flocculation. Flocculation can thus also occur in the roll assembly or in the fluid vessel. It is therefore advantageous if a drain opening is provided on the base side or in the vicinity of the base of the fluid vessel, via which drain opening sediment containing corresponding precipitated foreign matter can be drained.

At least one gas feed line can open into the or a housing of the roll assembly, said gas feed line being fed through a gas discharge opening on the upper side of the fluid vessel. As explained above, air with a high content of oxygen and/or ozone can for example be present in the fluid vessel because of electrolysis. In order to supply the relevant air to the roll assembly in a targeted manner, since large surface areas of the fluid are present there and the air can thus readily react with foreign matter or colloids, it is advantageous to provide the above-mentioned gas feed line.

In this connection, in particular a separate gas feed for each of the rolls can be undertaken in order to promote foaming in this region and to achieve a high concentration of oxidants in the region of the roll. In particular, a fan or the like can be used in order to increase the required quantity of gas.

A foam breaker is preferably arranged at the gas discharge opening. This can be advantageous since fluid conducted back by the roll assembly can have a certain foam content, and therefore there can be a layer of foam on the surface of the fluid vessel. However, the gas lines should typically be dry since they will otherwise potentially be closed by foam, or an additional outlay is required to isolate fans or the like. This can be achieved by a foam breaker in the region of the gas discharge opening.

The foam breaker can be in particular a mechanical foam breaker which has, for example, a driven disk with rods or other projections which whisk the foam and thus bring together gas bubbles and break down the foam. A drive can be undertaken, for example, by an electric motor.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

In the drawing:

FIG. 1 shows an exemplary embodiment of a treatment apparatus according to the invention which comprises an exemplary embodiment of the roll assembly according to the invention,

FIG. 2 shows the exemplary embodiment illustrated in FIG. 1 of the roll assembly according to the invention, and

FIGS. 3-5 show detailed views of this roll assembly.

### DETAILED DESCRIPTION OF THE INVENTION

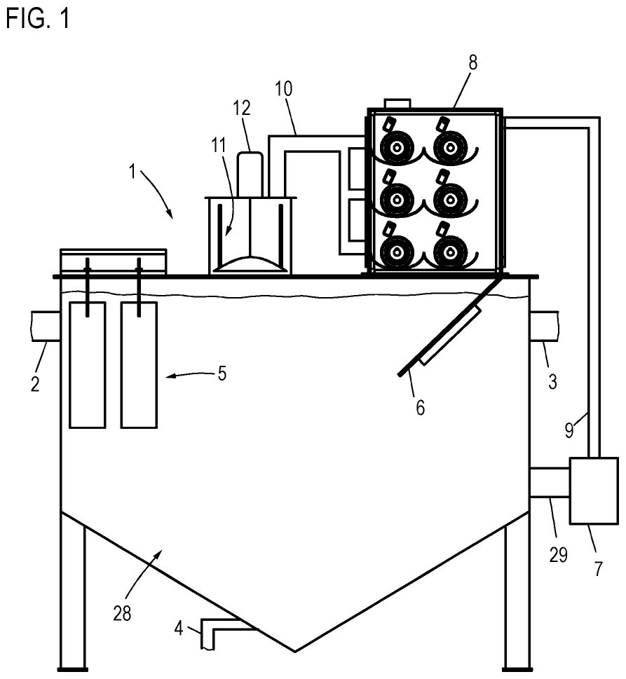

FIG. 1 shows a treatment apparatus 1 for fluid treatment. Said treatment apparatus comprises a fluid vessel 28, to which fluid for processing is fed via a fluid inlet 2. After the processing, the fluid is discharged from the fluid vessel 28 via the fluid outlet 3.

The fluid treated can in particular be water which is laden with foreign matter, in particular with colloids. The treatment apparatus can serve here in particular to treat colloids and other suspended matter in water, which cannot be readily removed by flocculation or addition of activated carbon within the scope of physical separation or can be removed only with long downtimes, in such a manner that they or constituents remaining after oxidation or the like can after such treatment be readily separated off by flocculation or addition of activated carbon, or under some circumstances even precipitate directly.

The treatment apparatus 1 which is shown can thus be used in particular within an extensive water treatment facility. For example, solids can already be separated off by pressing and/or filtering in upstream processing steps and foreign matter which can be readily flocculated can already have been flocculated. In addition or alternatively, foreign matter can already previously be oxidized or hydrated, for example in order to break open certain long-chain molecules even before the fluid is introduced into the fluid vessel 28.

As will be explained more precisely later, it is advantageous if the fluid which is supplied to the treatment apparatus 1 comprises at least a certain quantity of tensides or the like, in particular in order to bind non-polar foreign matter or foreign matter with low polarity in the fluid to said tensides or the like and thus to isolate them and, for example, to make them accessible for later flocculation. It is assumed below that there are already sufficient quantities of tensides or similarly acting substances in the fluid supplied via the fluid inlet 2. In principle, it would also be possible to introduce tensides or other desired additives into the fluid vessel in a targeted manner.

In the exemplary embodiment, the fluid flowing in via the fluid inlet 2 initially passes electrodes 5 of an electrolysis device that are charged with voltage by the latter in order in particular to cleave water into oxygen and hydrogen. Only two of the electrodes 5 are shown here in FIG. 1, but a plurality of said pairs of electrodes are preferably arranged offset with respect to one another perpendicular to the plane of the drawing in FIG. 1 in order to provide a large reaction surface for the electrolysis. It is advantageous here if the electrolysis device is designed in such a manner that a respective pair of electrodes 5 is in each case operated after a certain period of time with reverse polarity, i. e. if anode and cathode are swapped so as to avoid an accumulation of salt on the electrodes 5. For example, such a reversal of polarity can take place once per minute.

The electrolysis of the water has the effect, on the one hand, that a high oxygen content and also a significant content of ozone or oxygen radicals are present in the air situated above the fluid surface, which, as will be discussed in more detail further below, can contribute to the breakdown of foreign matter in the roll assembly 8. Furthermore, at least locally in the region of the respective electrodes, a higher concentration of H₃O⁺ and OH⁻ radicals than would otherwise be present in the water is achieved. This can locally contribute to the hydration of foreign matter, because it is for example no longer necessary to separate a hydrogen atom from the water molecule in order to utilize an OH— group for the hydration of a molecule.

If the circulation of the fluid within the context of the treatment, as discussed in more detail further below, furthermore results in a flow speed that is sufficiently high, the elevated H₃O⁺ and OH⁻ concentrations can also be present in other regions of the treatment apparatus 1, in particular in the roll assembly 8, because the transport of fluid can take place more quickly than a neutralization of H₃O⁺ and OH⁻ radicals by diffusion processes. The electrolysis by the electrodes 5 can thus promote oxidation processes and hydration processes of foreign matter in the water.

A fluid-deflecting plate 6 is arranged in the fluid vessel 28 in such a manner that the fluid inlet 2 and a fluid outflow of the roll assembly 8, discussed again further below, are arranged on the same side of said fluid-deflecting plate 6, whereas the fluid outlet 3 of the fluid vessel 28 is arranged on the other side of the fluid-deflecting plate 6. This has the effect that fluid that is fed via the fluid inlet 2 cannot flow directly to the fluid outlet 3, but rather is mixed with the fluid that has already been treated in the roll assembly 8, as a result of which the concentration of still-unprocessed foreign matter in the fluid is considerably reduced.

Since the fluid mixed in this way is furthermore, on its flow path to the fluid outlet 3, conducted past an intake opening 29 via which it is drawn in by means of the pump 7 and conveyed via the pipe 9 to the roll assembly 8, it can be achieved, through corresponding setting of the conveying rate of the pump in relation to the fluid quantity 1a that is fed via the fluid inlet 2 and discharged by the fluid outlet 3, that fluid which is supplied is, on average, conducted through the roll assembly 8 several times before being discharged via the fluid outlet 3. In this way, for the fluid in the fluid vessel 28 and in particular for the fluid that is discharged via the fluid outlet 3, a very low concentration of still-unprocessed foreign matter can be achieved.

As explained, the treatment apparatus 1 serves primarily to process foreign matter in the fluid in such a manner that they can be subsequently readily precipitated. Proportions of the foreign matter may nevertheless precipitate already in the treatment apparatus 1 itself. For example, in the case of the treatment of water that has been recovered from fermented slurry, for example from a biogas plant, relatively high pH values are encountered, such that, after a break-up of organometallic compounds, hydroxides of the metals are precipitated in most cases. In addition, it is possible for the supplied fluid to already contain activated carbon and/or flocculants that have been introduced into the fluid, for example in the previous processing steps. A sediment with a high concentration of precipitated foreign matter can thus form in the fluid vessel 28, which sediment can be extracted via a drain opening 4 situated close to the base.

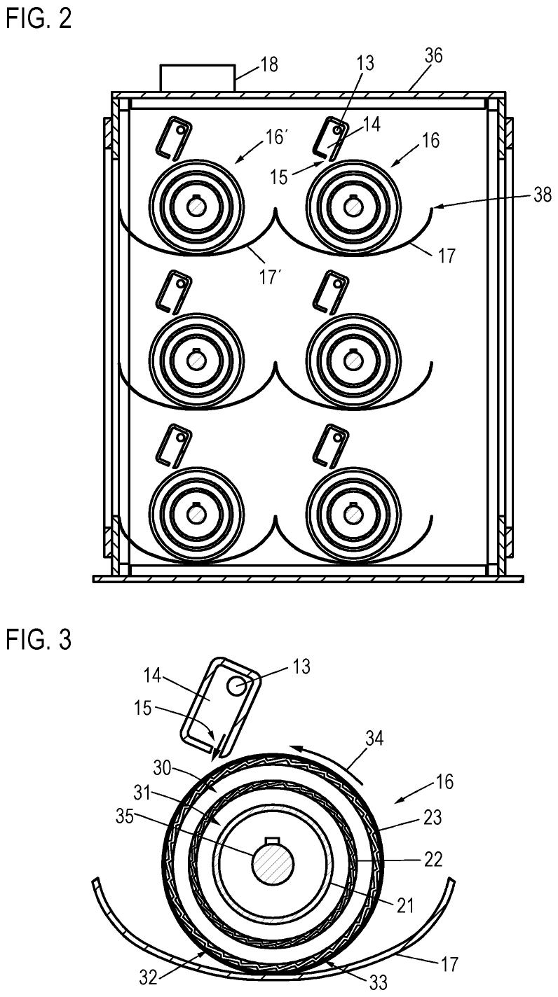

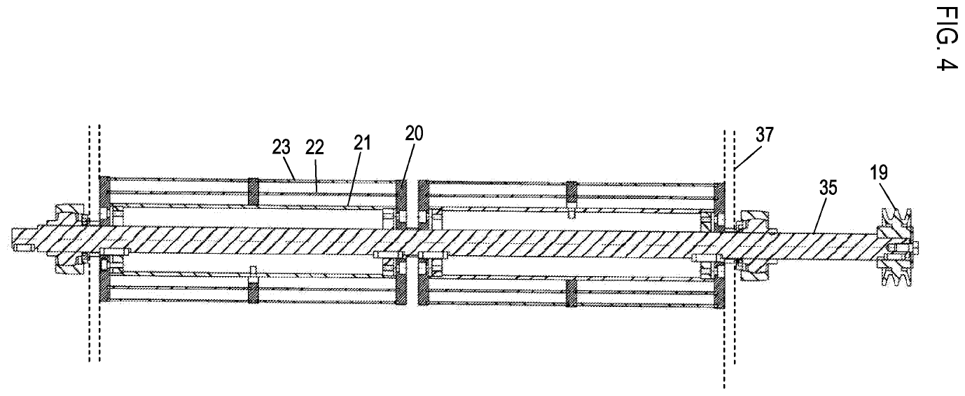

In order to achieve high throughputs with relatively compact dimensions of the treatment apparatus, on the one hand, and a low level of remaining unprocessed foreign matter in the fluid, on the other hand, the roll assembly 8 is utilized in the treatment apparatus 1 to enlarge the surface area of the fluid and generally increase the dynamics of reactions for the treatment. A detailed view of the roll assembly 8 is illustrated in FIG. 2. In the example, the roll assembly 8 comprises six rolls 16, 16′, which are supported by a housing 36 of the roll assembly 8 and which are driven by a common drive 18. The drive 18 is merely schematically illustrated in FIG. 2. The drive 18 may for example be an electric motor. The drive 18 may for example be coupled directly to the shaft 35, illustrated in FIGS. 3 and 4, of one of the rolls 16, 16′. The shafts 35 of the various rolls 16, 16′ may be coupled to one another in terms of movement, for example by means of V-belts.

The fluid that is drawn in by the pump 7 via the intake opening 29 is conducted via the pipe 9 to respective apertures 13 of the housing 36 of the roll assembly 8, which apertures are adjoined by water feeds 14 which conduct the inflowing fluid axially along the roll 16 and cause said fluid to flow through a gap or slot 15 or some other opening onto an outer lateral surface 23 of the respective roll 16, 16′. In the example shown, the fluid feeds 14 are formed by rectangular pipes with a gap or slot 15 running in the longitudinal direction of the pipe at or close to the lowest point. Other configurations would also be possible. It is essential that the fluid is applied to the outer lateral surface 23 in a manner distributed at least approximately uniformly along the axial direction of the respective shaft 16, 16′.

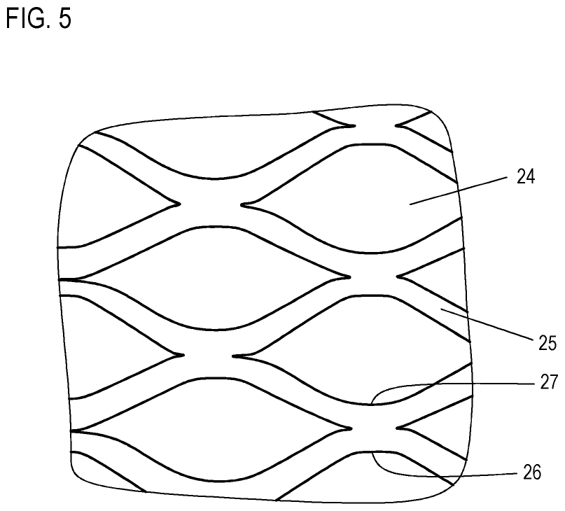

The respective rolls comprise, as can be seen in particular in FIGS. 3 and 4, two cylindrical lateral surfaces 22, 23 which are spaced apart from one another in a radial direction and which are each formed by a mesh. One example of such a mesh is illustrated in FIG. 5. Below the roll 16, 16′, there is arranged a respective collecting trough 17, 17′ which collects the fluid supplied via or by means of the roll 16, 16′. Here, the dimensions of the lateral surfaces 22, 23 are selected such that they project into the collecting trough 17, 17′ at the bottom side of the roll 16, 16′. Furthermore, radially within the inner lateral surface 22, there is situated a cylindrical inner shell 21, which is likewise connected rotationally conjointly to the shaft 35. As indicated by the arrow 34, the respective shaft 35 and thus the rolls 16, 16′ are rotated with a relatively high rotational speed of, for example, 1000 rpm.

The described arrangement has the effect that, in the case of the collecting trough 17′ being filled to a sufficient level with fluid, the two lateral surfaces 22, 23 dip into the fluid and, owing to the lateral surfaces 22, 23 being in the form of meshes and owing to the relatively fast rotation of the rolls 16, 16′, intensely swirl said fluid and entrain said fluid at least over a certain distance. Thus, in the intermediate spaces 30, 31 between the lateral surfaces 22, 23 and between the inner shell 21 and the lateral surface 22, which may for example have an extent of 1 to 1.5 cm in a radial direction, there is resulting hydrodynamic fluid movement and swirling of the fluid. This leads, on the one hand, to an acceleration of treatment processes within the fluid, that is to say for example of hydration of foreign matter.

On the other hand, in particular if tensides or other foaming agents are present in the fluid, there will result an intense foam formation, wherein the lateral surfaces 22, 23 in the form of meshes however simultaneously act as mechanical foam breakers, such that the foam or individual air bubbles in the foam have a very short lifetime of for example only approximately 2 ms. The interaction of the intense foam formation with the simultaneous rapid breakdown of the foam has the effect that very large surface areas are briefly provided, but at the same time a high throughput of fluid can be achieved.

As has already been explained in detail in the general part of the description, the formation of large surfaces leads, on the one hand to foreign matter in the fluid being able to interact to a considerably greater extent with supplied air, which, as explained above, can in particular have a particularly high content of oxygen or ozone. On the other hand, tensides present in the fluid are adsorbed on said surface and can thus form a large filter surface area in order to act on and to kill foreign matter, for example organic residues of oxidized molecules or viruses or bacteria.

As a result of the rotation of the rolls 16, 16′, fluid situated in the respective collecting trough 17, 17′ tends to be accelerated to the right in FIG. 2, such that, for the collecting trough 17, the fluid is sloshed or conveyed over the side wall 38 of the collecting trough 17, following which said fluid can fall vertically through the cavity, situated to the right of the collecting troughs 17, of the housing 36 of the roll assembly 40, which cavity forms the fluid outflow of the roll assembly 8, back into the fluid vessel 28, specifically on the left-hand side of the fluid-deflecting plate 6. This results in the mixing with freshly supplied fluid, as already discussed above.

Here, fluid that is situated in the collecting trough 17′ is firstly conveyed into the collecting trough 17, because the side walls 38 of the collecting troughs 17, 17′ are connected to one another in fluid-tight fashion. This has the effect, on the one hand, that fluid that is initially fed to the rolls 16′ can be processed twice in the roll assembly, specifically once by the roll 16′ and once by the roll 16. At the same time, this has the effect that the fluid that is fed to the roll 16 is diluted with the pre-processed fluid fed from the roll 16′, such that a lower concentration of still-unprocessed foreign matter is present in the region of the roll 16 than is the case for the roll 16′. As already explained in the general part, it has been recognized that the combination between a serial and a parallel processing of the fluid is particularly advantageous.

FIG. 4 shows one option for constructing rolls 16, 16′ and of mounting them on the housing 36 of the roll assembly 8. The housing walls 37 of the housing 36 of the roll assembly are illustrated by dashed lines. The housing walls 37 support a shaft 35 to which four supporting disks 20 are fastened. One pair of the supporting disks 20 in each case supports the inner and outer lateral surface 22, 23 in the shape of cylinder jackets and the inner shell 21, which is fluid-tight. Two rolls which are connected rotationally conjointly to the shaft 35 are thus formed in FIG. 4.

In the example shown, the shaft 35 is conducted on both sides through the respective housing wall 37 of the housing 36. This can serve for example to couple the shafts 35 to one another in the region of one of the housing walls 37, for which purpose a belt pulley 19 is provided on the shaft 35 in FIG. 4. Said belt pulley can be coupled to a respective shaft disk of one or more further shafts via a V-belt, for example. One of the shafts 35 can be driven directly, for example by one end of the shaft being coupled to the output shaft of the drive 18 in the region of the opposite housing wall 37.

The mesh which is illustrated by way of example in FIG. 5 and which forms the lateral surfaces 22, 23 can be designed in such a manner that the sawtooth surface structure illustrated schematically in FIG. 3 results. This leads overall, in conjunction with a small spacing between the outer lateral surface 35 and the base of the collecting trough 17, to a good break-up of hydrate shells and water clusters, which can suppress a reaction of foreign matter in the fluid. The fluid is hereby initially intensely compressed in the region 32 and subsequently suddenly expanded in the region 33. Together with the shear forces that arise in the constriction, water clusters can be broken up in this way.

A corresponding sawtooth structure for meshes results for example in the case of production of a rhomboidal mesh as an expanded mesh. If, for example, the apertures 24, illustrated in FIG. 5, between the mesh bars 25 are produced by slots initially being introduced and the mesh subsequently being expanded in the vertical direction in FIG. 5; this leads to an offset of the mesh bars 25 such that, for example, the edge 26 in FIG. 5 can be located considerably closer to the observer than the edge 27.

In order to firstly further assist the foam formation within the roll assembly and secondly achieve the high oxygen and ozone concentration, which occurs owing to the electrolysis of the fluid, also in the region of the rolls 16, 16′, use is made of gas feed lines 10 which are fed through a gas discharge opening at the top side of the fluid vessel 28. Since in particular the operation of the roll assembly 8 can have the effect that a foam layer forms on the surface of the fluid in the fluid vessel 28, and it is advantageously sought to prevent the gas discharge opening or the gas feed lines 10 from being covered with foam, which would restrict a feed of gas to the roll assembly 8, a foam breaker 11 is arranged in the region of the gas discharge opening, which foam breaker, in the example, is driven by an electric motor 12. As a foam breaker, use may for example be made of a disk with rods attached thereto, as is illustrated schematically in FIG. 1. Here, the rods are led rapidly through the foam and thus connect air bubbles, leading to the break-up of the foam. Alternatively or additionally, the foam can be broken up by baffle plates at which the foam bubbles burst.

While specific embodiments of the invention have been shown and described in detail to illustrate the inventive principles, it will be understood that the invention may be embodied otherwise without departing from such principles.

We claim:

1. A roll assembly for increasing a surface area of a fluid, in particular for water treatment, comprising at least one shaft which in each case bears at least one roll, a drive for the at least one shaft, a fluid feed which is arranged above the respective roll and guides the fluid to the respective roll, and a collecting trough for the fluid, said collecting trough being assigned to the respective roll, wherein the roll has two lateral surfaces in the shape of cylinder jackets which are spaced apart in the radial direction, are each in the form of a mesh and project on the bottom side of the roll into the collecting trough.

2. The roll assembly according to claim 1, wherein the outer of the lateral surfaces has a spacing of less than 3 mm or less than 2 mm or less than 1.5 mm from a base of the collecting trough.

3. The roll assembly according to claim 1, wherein at least the outer surface area of the outer of the lateral surfaces has a sawtooth form, apart from the mesh apertures in the circumferential direction.

4. The roll assembly according to claim 1, wherein the inner and/or outer of the lateral surfaces is formed by a rhomboidal mesh, in particular by a rhomboidal expanded mesh.

5. The roll assembly according to claim 1, wherein the fluid supply is formed by a pipe which, at least in one axial portion that extends above the outer lateral surface in the axial direction of the shaft, has a slot through which fluid conducted in the pipe can escape from the pipe.

6. The roll assembly according to claim 1, wherein the respective roll comprises a fluid-tight inner shell which is in the form of a cylinder jacket and extends between the shaft and the inner of the lateral surfaces.

7. The roll assembly according to claim 1, wherein it comprises a first shaft which bears a first roll, to which a first collecting trough is assigned, and a second shaft which runs parallel to the first shaft and bears a second shaft, to which a second collecting trough is assigned, wherein the first collecting trough and the second collecting trough are arranged adjacent to one another in a direction perpendicular to the axial direction of the rolls, wherein a side wall of the first collecting trough at the same time forms a side wall of the second collecting trough or is connected fluid-tightly to a side wall of the second collecting trough.

8. The roll assembly according to claim 1, wherein it comprises a plurality of shafts, wherein the shafts are mounted on a housing and penetrate at least one housing wall of the housing, and/or wherein the shafts, in particular outside the housing, are coupled in terms of movement to one another, and/or the fluid feeds of the rolls arranged on the shafts are connected to a common pump for loading the fluid feeds with the fluid.

9. A treatment apparatus for fluid treatment, with a fluid vessel which comprises a fluid inlet for supplying fluid to be treated, and a fluid outlet for conducting away treated fluid, wherein it comprises a roll assembly according to claim 1, wherein an intake opening of the fluid vessel is fluidically connected to the at least one fluid feed, in particular via the or a pump, wherein a fluid outflow of the roll assembly, to which fluid passing via the or a side wall of the at least one collecting trough can be supplied, opens into the fluid vessel.

10. The treatment apparatus according to claim 9, wherein the roll assembly is arranged in the or a housing which has a cavity which is laterally adjacent to the collecting trough or to at least one of the collecting troughs, is open on its bottom side and into which the fluid vessel opens and thus forms the fluid outflow of the roll assembly.

11. The treatment apparatus according to claim 9, wherein it has a fluid-deflecting plate which projects into the fluid vessel and ends freely in the fluid vessel, wherein the fluid inlet of the fluid vessel and the fluid outflow of the roll assembly are arranged on one side of the fluid-deflecting plate and the fluid outlet of the fluid vessel and/or the intake opening are arranged on the opposite other side of the fluid-deflecting plate.

12. The treatment apparatus according to claim 11, wherein the fluid outlet of the fluid vessel is arranged above the free end of the fluid-deflecting plate, wherein the intake opening is arranged lower than the fluid outlet, in particular below the free end of the fluid-deflecting plate.

13. The treatment apparatus according to claim 9, wherein it has at least one pair of electrodes which project into the fluid vessel, wherein an electrolysis device is designed to charge the electrodes with voltage in order to carry out electrolysis of the fluid.

14. The treatment apparatus according to claim 9, wherein at least one gas feed line opens into the or a housing of the roll assembly, said gas feed line being fed through a gas discharge opening on the upper side of the fluid vessel.

15. The treatment apparatus according to claim 14, wherein a foam breaker is arranged at the gas discharge opening.
